(19) United States
(12) Patent Application Publication
(10) Pub. No.: US 2008/0001468 A1
(43) Pub. Date: Jan. 3, 2008

(54) Multiple Clad Wheel Assembly

(76) Inventors: Gregory R. Hauler, Whitehall, MI (US); Kevin J. Wardynski, Stanwood, MI (US); Kevin M. Chinavare, Middleville, MI (US); Brian Lutt, New Baltimore, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/768,228

(22) Filed: Jun. 26, 2007

Related U.S. Application Data
(60) Provisional application No. 60/816,521, filed on Jun. 26, 2006.

(51) Int. Cl. B60B 25/00; B21D 53/30

(52) U.S. Cl. 301/37.105; 29/894.3

(57) ABSTRACT

A motorcycle wheel assembly comprises a wheel having opposite outer surfaces, and a pair of claddings covering the opposite surfaces to provide an aesthetic covering on both sides of the associated wheel assembly. The claddings cooperate and engage one another to securely attach to the associated wheel, to provide alignment therebetween, to provide a wheel assembly having the aesthetic appearance of a solid wheel and other aesthetic improvements.

This application claims the benefit of U.S. Provisional Application No. 60/816,521, filed Jun. 26, 2006, entitled MULTIPLE CLAD WHEEL ASSEMBLY, which is hereby incorporated herein by reference in its entirety.

### BACKGROUND OF THE INVENTION

The present invention relates to wheel assemblies, and in particular to wheel assemblies for motorcycles that include cladding on opposing outside surfaces of an associated wheel.

Ornamental metal-plated polymeric claddings have been employed for providing a decorative surface to the outer exposed surface of wheels for several years. U.S. Pat. Nos. 5,564,791; 5,577,809; 5,597,213; 5,630,654; 5,636,906; 5,845,973 and 6,085,829, the disclosures of which are incorporated herein by reference, represent different approaches for providing and attaching such claddings to existing wheels to provide a finished decorative appearing wheel. These wheel claddings offer design flexibility and allow wheel claddings of various configurations to be used to cover a single style wheel.

Heretofore, wheel cladding techniques have been applied primarily to four or more wheeled vehicles which require cladding only on a single, outer exposed surface of each exposed wheel. However, similar applications to a motorcycle wheel would require cladding of both sides of the associated wheel as both sides of the wheel are exposed. Previous cladding assemblies and methods known in the art do not address the unique configurations presented when attempting to clad or aesthetically cover both sides of an associated wheel.

### SUMMARY OF THE INVENTION

The present inventive motorcycle wheel assembly comprises a wheel having a first outer surface, a second outer surface opposite the first outer surface, a central hub region, an outer rim portion, and a centrally-located hub aperture extending through the wheel, a first wheel cladding having an outer surface and an inner surface facing the first outer surface of the wheel, and a first edge, and a second wheel cladding having an outer surface and an inner surface facing the second surface of the wheel, and a second edge. The second edge of the wheel cladding engages the first edge of the first wheel, and at least a select one of the first edge and the second edge includes at least one first tab member, wherein the remaining edge of the first wheel cladding and second wheel cladding includes a pair of second tab members that receives the at least one first tab member therebetween, thereby interconnecting the first and second wheel claddings together.

Another aspect of the present invention is to provide a motorcycle wheel assembly that comprises a wheel having a first outer surface, a second outer surface opposite the first outer surface, a central hub region, an outer rim portion, and a centrally-located hub aperture extending through the wheel, a first wheel cladding having an outer surface and an inner surface facing the first outer surface of the wheel, and a first edge, and a second wheel cladding having an outer edge and an inner surface facing the second surface of the wheel, and a second edge. The motorcycle wheel assembly further includes a connector member extending radially along at least a select one of the central hub region and the outer rim portion, wherein the connector member is located between the first and second edges and provides a transition between the first and second wheel claddings.

Still another aspect of the present invention is to provide a motorcycle wheel assembly that comprises a wheel having a first outer surface, a second outer surface opposite the first outer surface, a central hub region, an outer rim portion, and a centrally-located hub aperture extending through the wheel, a first wheel cladding having an outer surface and an inner surface and at least partially abutting the first outer surface of the wheel, and a second wheel cladding having an outer surface and an inner surface and at least partially abutting the second outer surface of the wheel. The motorcycle wheel assembly further includes a third wheel cladding having an outer surface and an inner surface facing and at least partially abutting the outer face of the first wheel cladding, and a fourth wheel cladding having an outer and an inner surface facing and at least partially abutting the outer surface of the second wheel cladding.

Still another aspect of the present inventive motorcycle wheel assembly comprises a wheel having a first outer surface, a second outer surface opposite the first outer surface, a central hub region, an outer rim portion, and a plurality of structural members extending radially between the central hub region and the outer rim portion defining a plurality of apertures therebetween. The motorcycle wheel assembly further comprises a first wheel cladding having an outer surface and an inner surface facing the first outer surface of the wheel, and a second wheel cladding having an outer surface and a inner surface facing the second surface of the wheel, wherein the first and second wheel claddings cooperate to completely cover each of the apertures, thereby providing the aesthetic appearance of a solid wheel.

A further aspect of the present invention is a motorcycle wheel assembly that comprises a wheel having a first outer surface, a second outer surface opposite the first outer surface, a central hub region, an inner rim portion, a rim flange circumscribing the rim portion, and a centrally-located hub aperture extending through the wheel. The motorcycle wheel assembly further comprises at least one wheel cladding having an outer surface and an inner surface facing at least one of the outer surfaces of the wheel, an outer radial edge and an inner radial edge, wherein the outer radial edge of the wheel cladding extends up to but does not cover the rim flange.

Still yet another aspect of the present invention includes a method for manufacturing a motorcycle wheel assembly comprising placing a first wheel cladding on a fixture such that an outer surface of the first wheel cladding faces the fixture, applying an adhesive to a select one of the inner surface of the first wheel cladding and the outer surface of the wheel, and placing the wheel on the first wheel cladding such that the first outer surface of the wheel faces the inner surface of the first wheel cladding. The method further comprises applying an adhesive to a select one of a second outer surface of the wheel and an inner surface of the second wheel cladding, and placing the second wheel cladding on the wheel such that the inner surface of the second wheel cladding faces the second outer surface of the wheel. The method further comprises placing a spacer on an outer surface of the second wheel cladding, and applying a clamping pressure to the spacer, thereby clamping the first wheel cladding, the wheel and the second wheel cladding together.

The present inventive wheel assembly provides an aesthetic cladding cover to both sides of an associated wheel, thereby providing high adaptable design and a low-cost alternative to aesthetically-finished steel or aluminum wheels. The wheel assembly is also durable, permanently bonded to the wheel, and in certain embodiments sealed from the elements thereby preventing degradation thereto. Moreover, the wheel assembly reduces associated manufacturing costs, can be easily and quickly assembled, is efficient to use, is more economical to manufacture, is capable of a long-operating life, and is particularly well adapted for the proposed use.

These and other advantages of the invention will be further understood and appreciated by those skilled in the art by reference to the following written specification and appended drawings.

### BRIEF DESCRIPTION OF THE DRAWINGS

FIG. 1 is a perspective assembled view of a wheel assembly embodying the present invention;

FIG. 2 is an exploded perspective view of the wheel assembly;

FIG. 3 is a front elevational view of the wheel assembly;

FIG. 4 is a side cross-sectional view of the wheel assembly along the line IV-IV, FIG. 3;

FIG. 5 is an enlarged view of an inner connection of a first cladding member and a second cladding member proximate a central hub of the wheel of the wheel assembly taken of the area V, FIG. 4;

FIG. 6 is a cross-sectional end view of a spoke of the wheel assembly taken along the line VI-VI, FIG. 3;

FIG. 7 is an enlarged cross-sectional view of a first alternative inner connection of the first and second cladding members taken of the area VII, FIG. 4;

FIG. 8 is an enlarged cross-sectional view of a second alternative inner connection of the first and second cladding members;

FIG. 9 is an enlarged cross-sectional view of a third alternative inner connection between the cladding members that incorporates a connector member having an I-shaped cross section;

FIG. 10 is an enlarged cross-sectional view of an alternative embodiment to the inner connection between the cladding members that includes a raised stud in-molded with the vehicle wheel.

FIG. 11 is an enlarged cross-sectional view of a first alternative embodiment to the in-molded stud embodiment, and includes a T-shaped in-molded stud;

FIG. 12 is an enlarged cross-sectional view of a second alternative to the in-molded stud, and includes a T-shaped stud formed separately from the wheel;

FIG. 13 is a perspective view of an edge portion of the first cladding member that includes an engagement channel;

FIG. 14 is an alternative embodiment of that which is illustrated in FIG. 13 and includes a cooperating pin and boss arrangement;

FIG. 15 is a front elevational view of a first alternative embodiment of the wheel assembly;

FIG. 16 is a cross-sectional side view of the first alternative embodiment to the wheel assembly taken along the line XVI-XVI, FIG. 15;

FIG. 17 is an alternative embodiment of that which is illustrated in FIG. 16;

FIG. 18 is a perspective view of a second alternative embodiment of a wheel assembly;

FIG. 19 is an exploded perspective view of the second alternative embodiment of the wheel assembly;

FIG. 20 is a front elevational view of the second alternative embodiment of the wheel assembly;

FIG. 21 is a cross-sectional side view of the second alternative embodiment of the wheel assembly taken along the line XXI-XXI, FIG. 20;

FIG. 22 is an exploded view of a third alternative embodiment of the wheel assembly that includes the wheel having a plurality of apertures extending therethrough and a pair of wheel claddings that cooperate to fully cover the apertures;

FIG. 23 is a front elevational view of the wheel assembly of FIG. 22;

FIG. 24 is a cross-sectional view of the third alternative embodiment of the wheel assembly taken along the line XXIII-XXIII, FIG. 23;;

FIG. 25 is a schematic plan view of a manufacture cell useful in the manufacture of the wheel assembly;

FIG. 26 is a top perspective view of a fixture assembly;

FIG. 27 is a top perspective view of a fixture assembly with a first cladding member nested thereon;

FIG. 28 is a top perspective view of a fixture assembly with a vehicle wheel nested thereon;

FIG. 29 is a top perspective view of a fixture assembly with a second cladding member nested thereon; and

FIG. 30 is a top perspective view of a fixture assembly with a spacer element nested thereon.

### DETAILED DESCRIPTION OF THE PREFERRED EMBODIMENTS

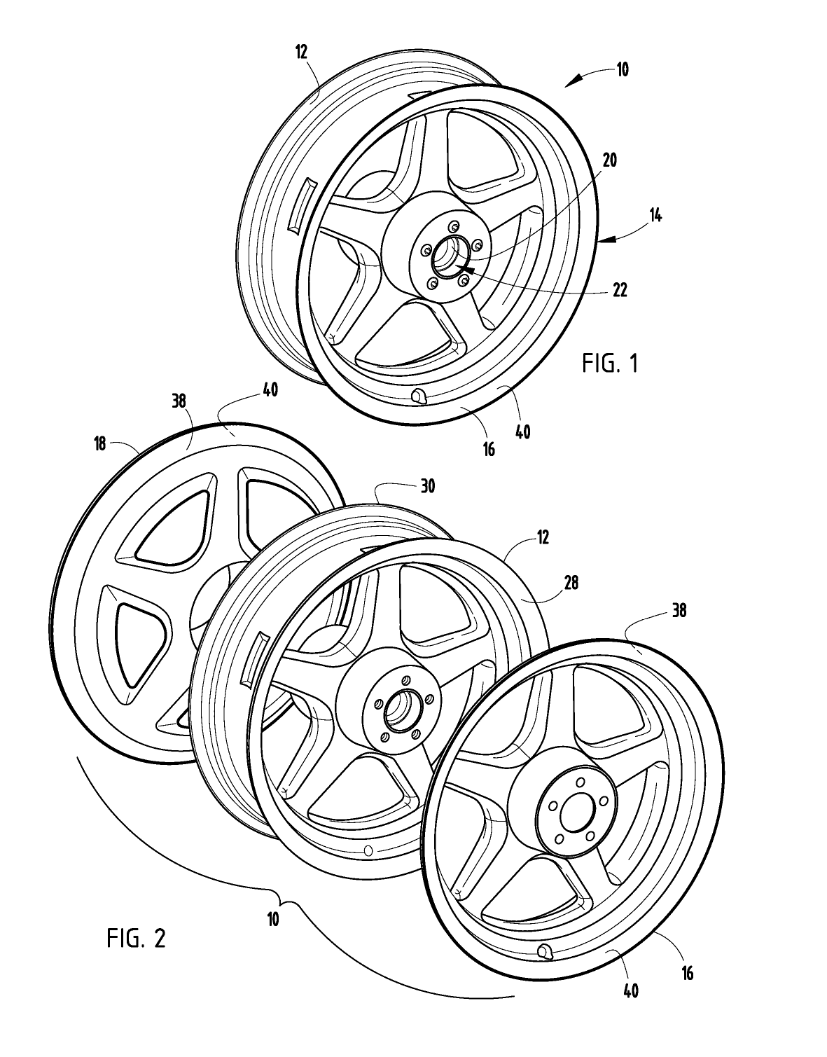

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

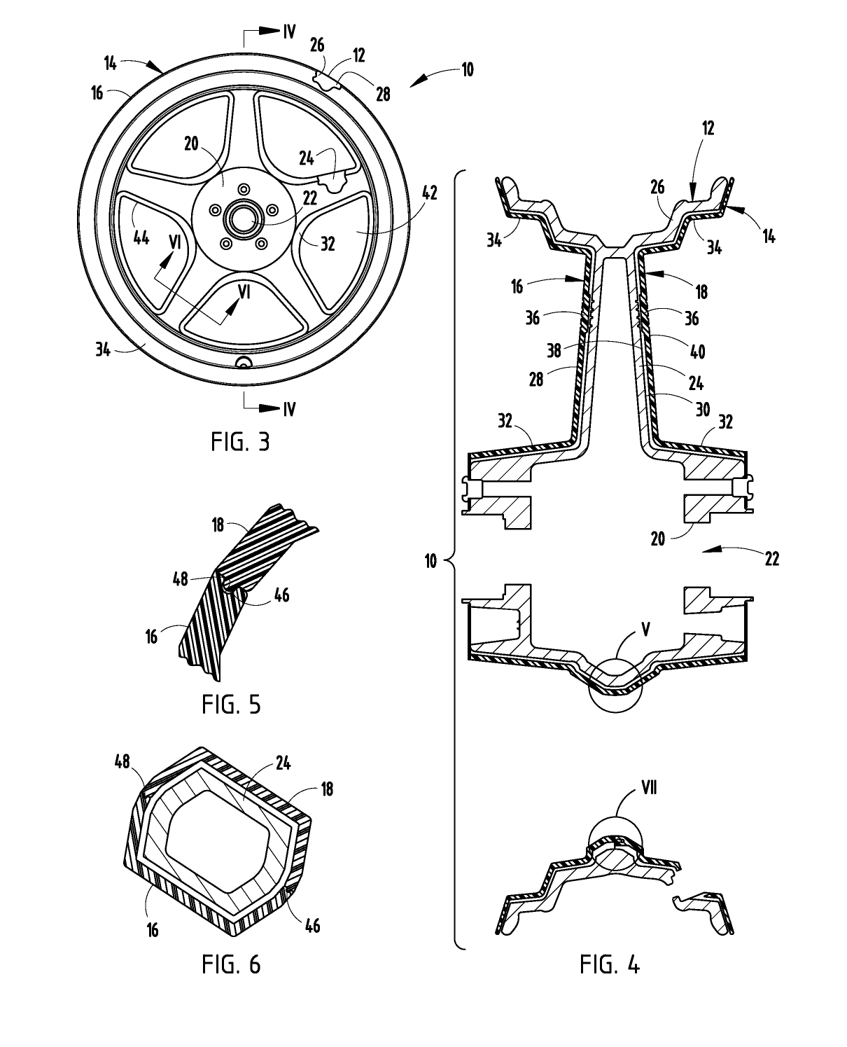

The reference numeral 10 (FIGS. 1-4) generally designates a wheel assembly embodying the present invention. The wheel assembly includes a wheel 12 covered by a cladding assembly 14 that includes a first cladding member or first wheel cladding 16 and a second cladding member or second wheel cladding 18. The wheel 12 includes a central hub 20 having a hub aperture 22 extending therethrough and configured to receive an axle therein. The wheel 12 further includes a plurality of spokes 24 spaced radially about the central hub 20 and connecting the central hub 20 with a rim 26. The spokes 24 and the rim 26 cooperate to define a first outer surface 28 and a second outer surface 30 opposite the first outer surface 28. In the illustrated example, each cladding member 16, 18 includes a central portion 32, a rim portion 34, and a plurality of spokes 36 extending radially between the central portion 32 and the rim portion 34 and connecting the same. Each cladding member 16, 18 further includes an inner surface 38 and an outer surface 40. The inner surface 38 of each of the cladding members 16, 18 is configured to generally conform to the corresponding outer surfaces 28, 30 of the wheel 12. The central portion 32, the rim portion 34 and the spokes 36 of each of the cladding members 16, 18 cooperate to define a plurality of openings 42 spaced radially about the wheel assembly 10. Each opening 42 is defined by an edge 44. In the illustrated example, the first cladding member 16 engages with the second cladding member 18 about the edge 44 of each opening 42. Specifically, as best illustrated in FIGS. 5 and 6, the second cladding member 18 includes a longitudinally-extending tab 46 that is tightly received within a corresponding longitudinally-extending groove 48 of the first cladding member 16. The tab 46 and groove 48 of the second cladding member 18 and first cladding member 16, respectively, extend about the opening 42 proximate the spokes 36.

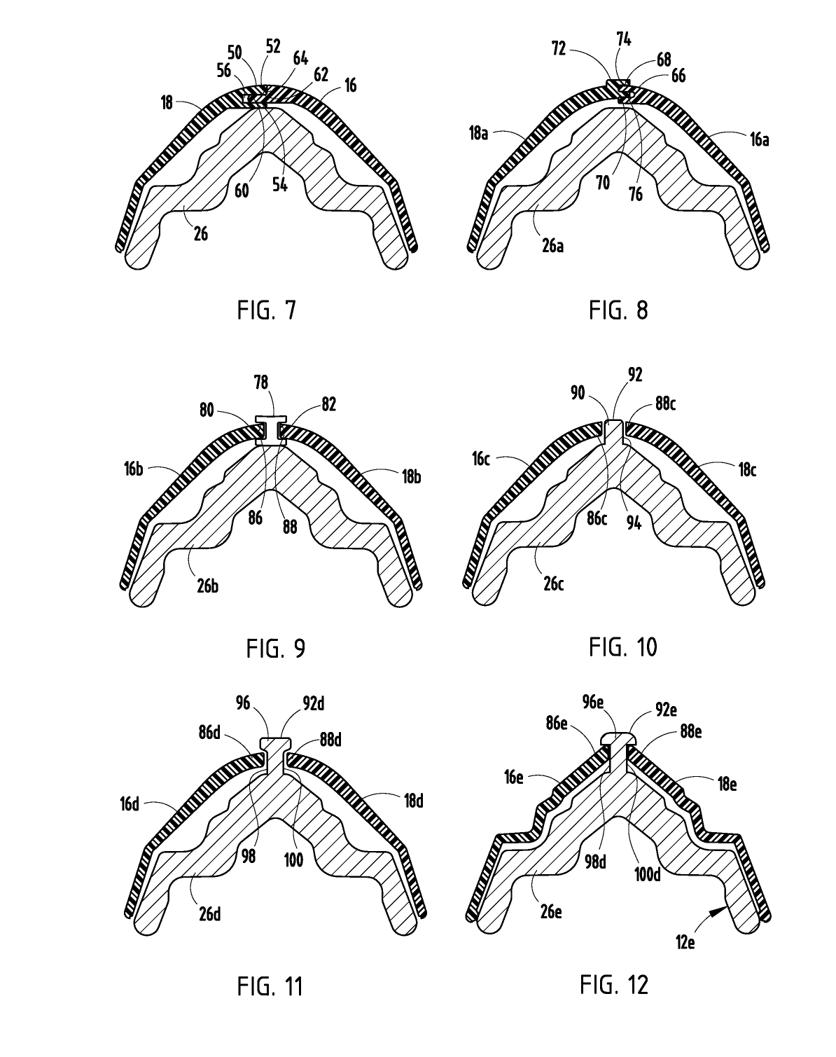

The second cladding member 18 (FIG. 7), proximate the rim 26, includes a longitudinally-extending fork 50 having a first finger 52 and a second finger 54 that cooperate to define a groove 56 therebetween. The first cladding member 16, proximate the rim 26, includes a tab 60 that is tightly received within the groove 56 and an end wall 62 that abuts an end 64 of the first finger 52, such that a seamless transition is formed between the first cladding member 16 and the second cladding member 18.

FIG. 8 illustrates an alternative embodiment to the inner connection between the first cladding member 16a and the second cladding member 18a along the edge 44 proximate the rim portions 34 thereof. In this alternative embodiment, the first cladding member 16a includes a first fork member 66 having a first finger 68 and a second finger 70 and a second fork member 72 having a first finger 74 and a second finger 76. As illustrated, the first finger or tab 68 of the first fork member 66 is tightly received between first finger or tab 74 and the second finger or tab 76 of the second fork member 72 while the second finger 76 of the second fork member 72 is tightly received between the first finger 68 and the second finger 70 of the first fork member 66. The second finger 76 of the second fork member 72 is slightly raised to provide an aesthetic ridge proximate the inner connection between the first cladding member 16a and the second cladding member 18a.

FIG. 9 illustrates another alternative embodiment of the inner connection between the first and second cladding members 16b, 18b. In the illustrated example, a longitudinally-extending connector 78 is located between a first cladding member 16b and the second cladding member 18b. Specifically, the connector 78 is provided with an I-beam shaped cross-sectional configuration including a first channel 80 and a second channel 82 that receives an edge 86 of the first cladding member 16b and an edge 88 of the second cladding member 18b therein. In another alternative embodiment, the I-beam shaped connector 78 is replaced by a radially-extending ridge 90 (FIG. 10) integrally molded with the rim 26c and including an exposed outer surface 92 and a pair of abutment walls 94 which are abutted by the edges 86c, 88c of the cladding members 16c, 18c. In yet another alternative embodiment, as illustrated in FIG. 11, the ridge 90 of the previous embodiment is replaced by a T-shaped ridge 96 that includes channels 98, 100 to receive the edges 86d, 88d of the cladding members 16d, 18d therein. The ridge 96 may also be formed as a ridge member 96e (FIG. 12) formed as a separate piece from the wheel 12a.

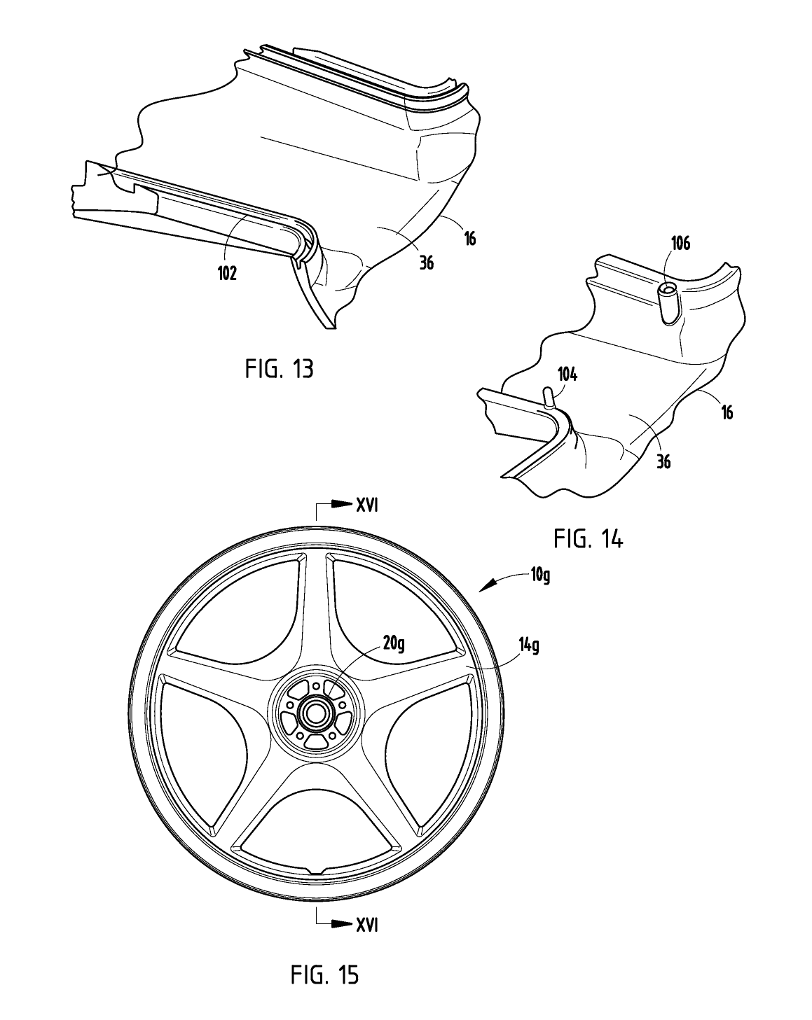

Other configurations for the inner connection and alignment of the first cladding member 16 with a second cladding member 18 may also be utilized, including the example illustrated in FIG. 13 that includes a deep, longitudinally-extending groove 102 that mates with a corresponding tab member (not shown) of the second clad member 18. FIG. 14 illustrates an alternative pin 104 and receiving boss 106 arrangement that are strategically spaced about the interface between the first cladding member 16 and the second cladding member 18, thereby assuring proper alignment thereof with respect to one another as well as the associated wheel 12.

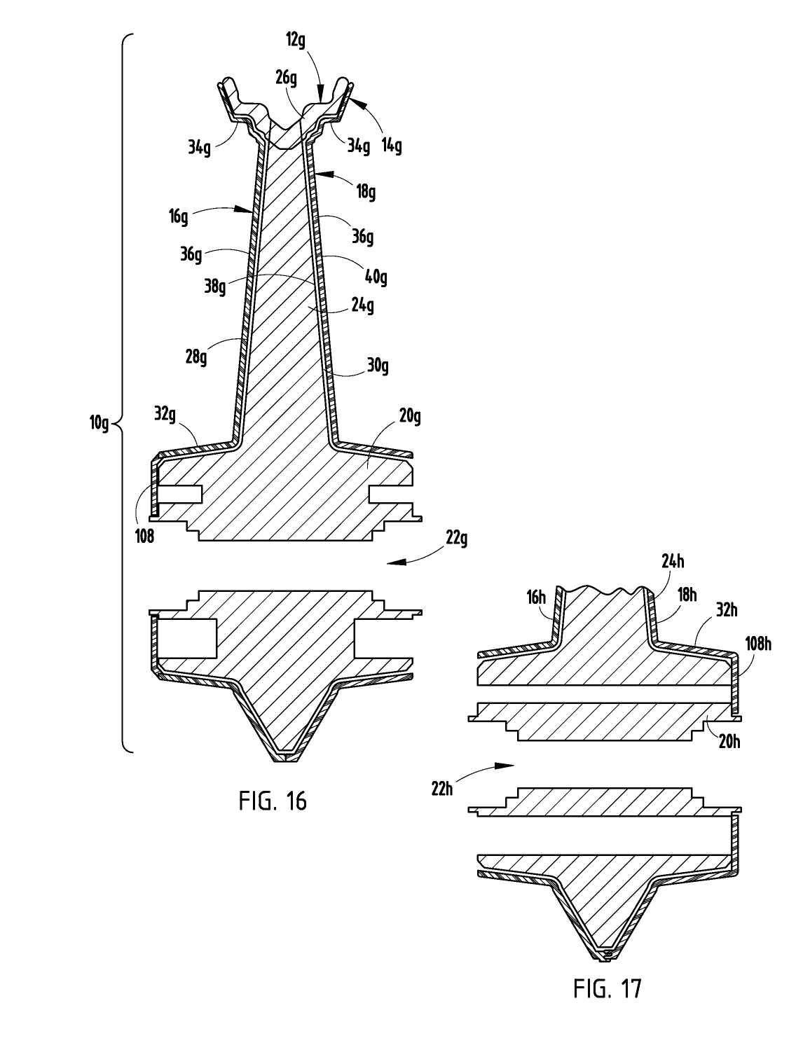

Reference numeral 10g (FIGS. 15 and 16) generally designates another embodiment of the present invention. Since the wheel assembly 10g is similar to the previously described wheel assembly 10, similar parts appearing in FIGS. 1-4 and FIGS. 15 and 16, respectively, are represented by the same, corresponding numeral, except for the suffix “g” in the numerals of the latter. The wheel assembly 10g includes a cladding assembly 14g that encompasses the central hub 20g of the associated wheel 12g. Specifically, a separate cap member 108 is coupled to the central portion 32g of the cladding members 16g, 18g, thereby aesthetically covering the central hub 20g of the wheel 12g without need for aesthetically finishing the central hub 20g of the wheel 12g. In the example illustrated in FIGS. 15 and 16, the cap member 108 is provided as a separate piece from the first cladding member 16g and the second cladding member 18g. However, as best illustrated in FIG. 17, the cap member 108h may be integrally formed with the cladding members 16h, 18h.

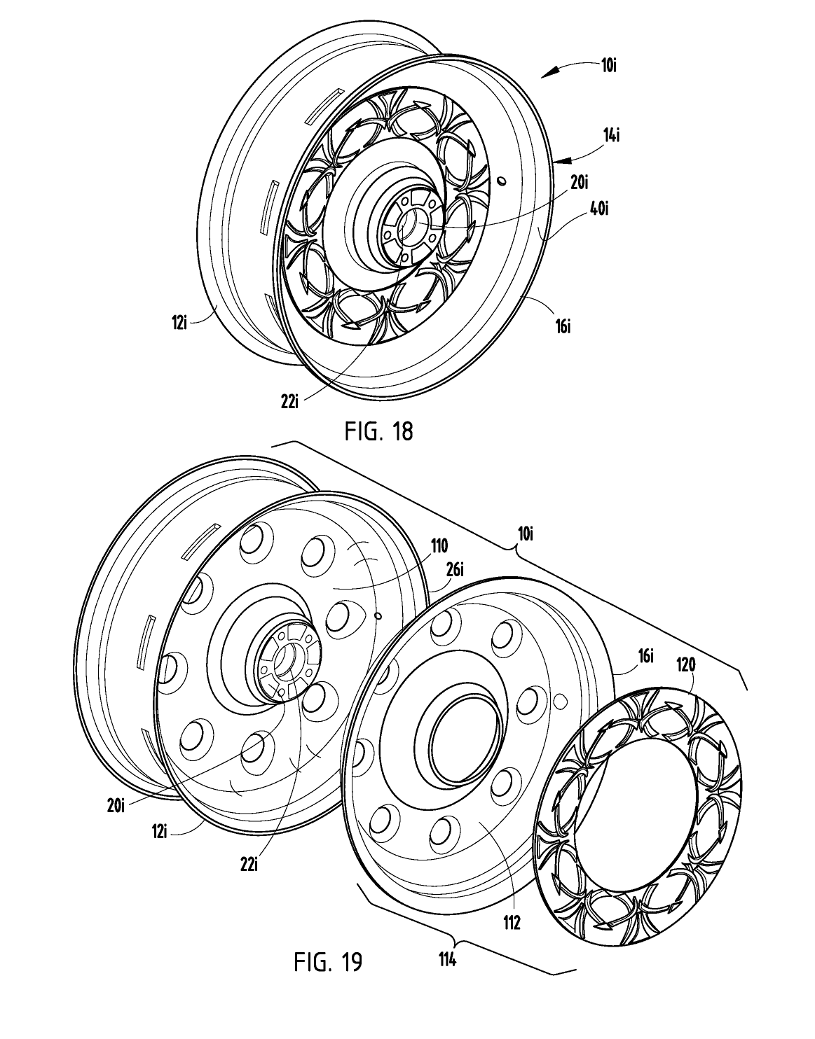

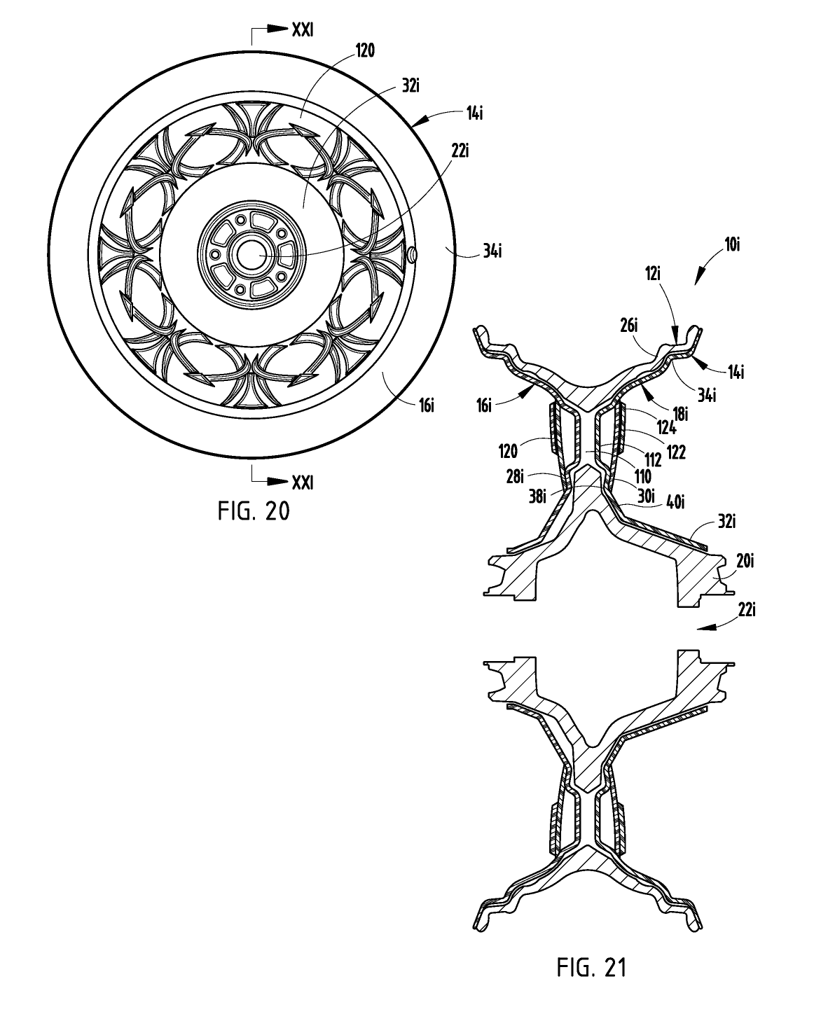

The reference numeral 10i (FIGS. 18-21) generally designates another embodiment of the present invention. Since the wheel assembly 10i is similar to the previously described wheel assembly 10, similar parts appearing in FIGS. 14 and FIGS. 18-21, respectively, are represented by the same, corresponding reference numeral, except for the suffix “i” in the numerals of the latter. The wheel assembly 10i is similar to the wheel assembly 10 with the most notable difference being the replacement of the spokes 24 of the wheel 12 with a web 110 extending between the central hub 20i and the rim 26i. In a similar manner, the cladding members 16i, 18i each include a web portion 112, corresponding to the web 110 of the wheel 12i. In the illustrated example, the first and second cladding member 16i, 18i are a part of a first and second cladding assemblies 114, 116 that include a first cladding insert 120 and a second cladding insert 122, respectively. The cladding inserts 120, 122 are attached to the outer surface 40i of the corresponding cladding members 16i, 18i, and add an additional level of aesthetic covering to the overall cladding assembly 14i. Specifically, the outer surface 124 of each of the cladding inserts 120, 122 may be finished with a different detail than the outer surface 40i of the cladding members 16i, 18i, i.e., differing surface coatings, textures, and the like, thereby allowing significant flexibility in design of each individual wheel assembly 10i. It is further contemplated that the cladding inserts 120, 122 may be substituted by or used in conjunction with aesthetically finished and/or patterned outer surfaces on the cladding members 16i, 18i.

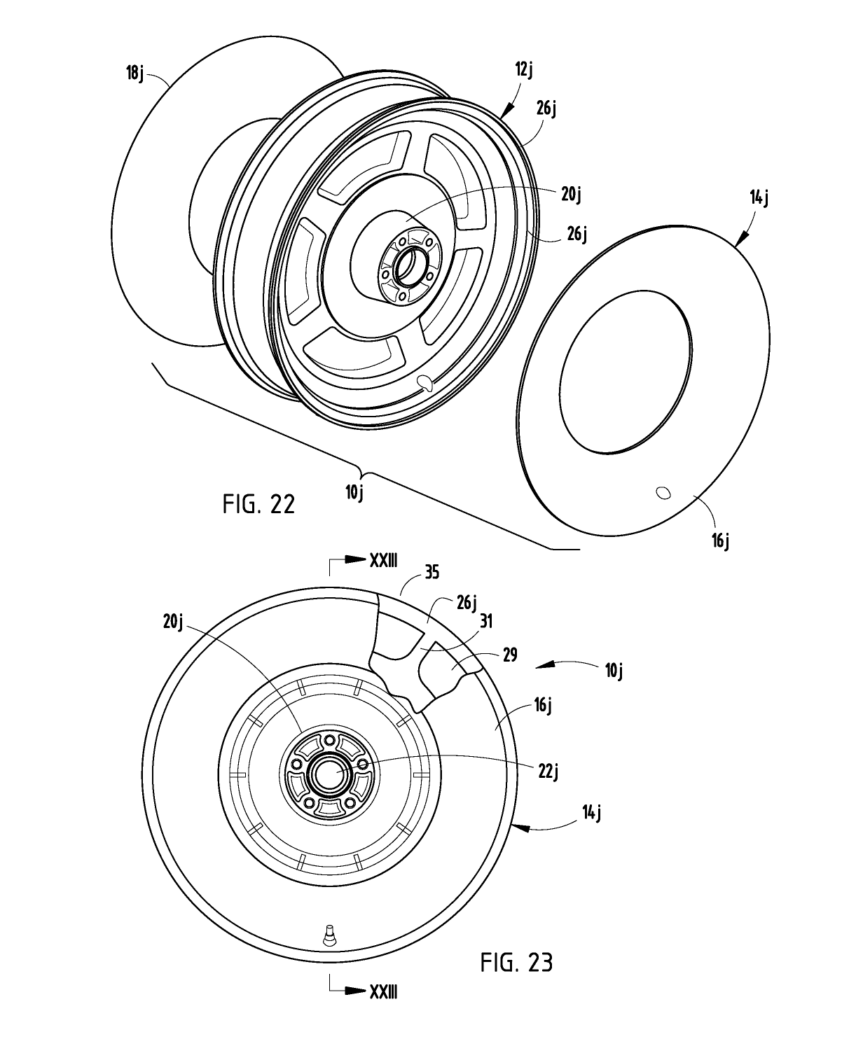

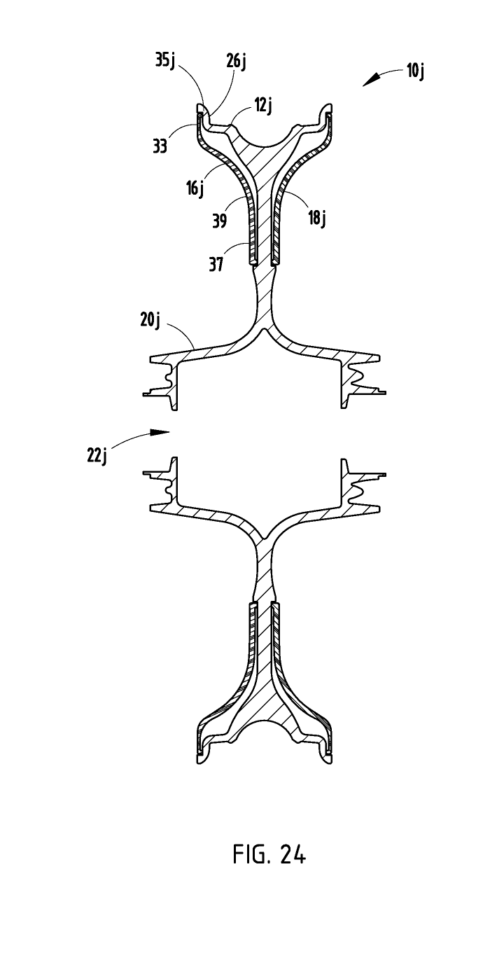

The reference 10j (FIGS. 22-24) generally designates yet another embodiment of the present invention. Since the wheel assembly 10j is similar to the previously described wheel assembly 10, similar parts appearing in FIGS. 14 and FIGS. 22-24, respectively, are represented by the same, corresponding reference numeral, except for the suffix “j” in the numerals of the latter. The wheel 12j includes a plurality of apertures 29 located between an outer rim 26j and a central hub region 20j and as defined by a plurality of radially spaced structural members 31 extending between the central hub region 20j and the outer rim 26j. As illustrated, the first and second cladding members 16j, 18j cooperate to completely cover the apertures 29 to provide the aesthetic appearance of a solid wheel construction without apertures. As best illustrated in FIG. 24, the cladding is positioned between the central hub region 20j and the outer rim 26j such that the claddings 16j, 18j cover the outer rim 26j and the respective side of the wheel 12j, but do not cover an outer flange 35. Further, each of the claddings 16j, 18j are configured such that an inner most radial edge 37 is countersunk with the wheel 12j, and the outer surface of the claddings 16j, 18j is flush-mounted with the respective outer surface of the wheel 12j. It is noted that the claddings 16j, 18j may cooperate with the wheel 12j to form gaps 41 therebetween.

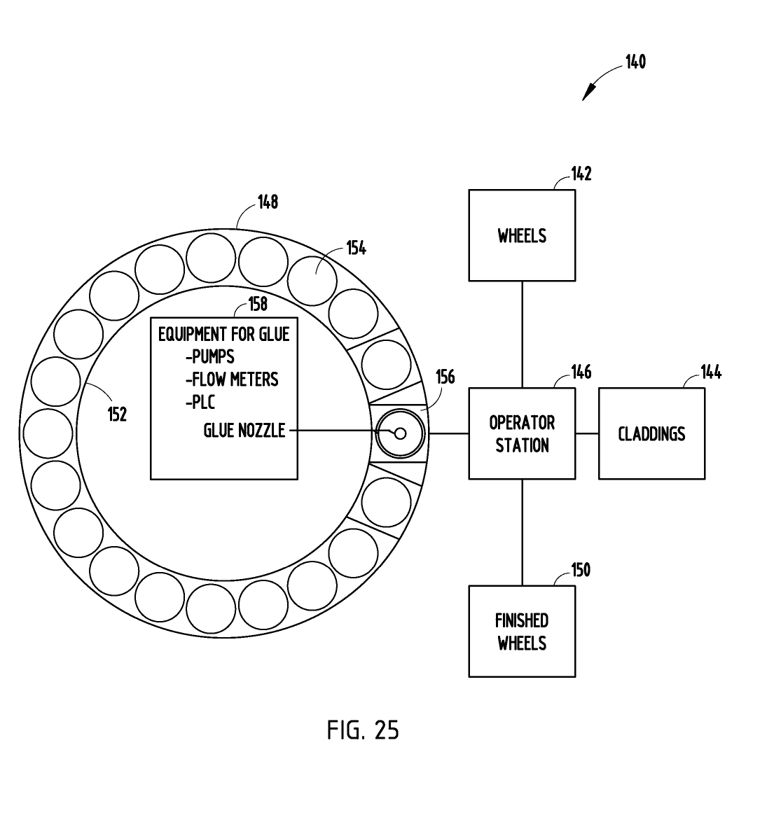

A manufacturing cell 140 (FIG. 25) for manufacturing of the wheel assembly 10, includes a wheel supply station 142, a cladding supply station 144, an operator station 146 within operable reaching distance from the wheel supply station 142 and the cladding supply station 144, an assembly center 148, and a finished wheel station 150 that receives the finished wheel assemblies 10 after removal from the assembly center 148. The assembly center 148 comprises a carousal-type assembly hub 152 rotatable about a given point and including a plurality of fixture assemblies 154 spaced radially thereabout. A glue station 156 is positioned proximate the operator station 146, and is positioned so as to sequentially receive the first cladding member 16, the wheel 12 and the second cladding member 18 thereon and are secured to one another via an adhesive as dispensed by gluing equipment 158, as described below. Each fixture assembly 154 (FIG. 26) includes a fixture 160 having a plurality of clamping members spaced radially thereabout. In the illustrated example, clamping members 162 comprise the Destaco-type clamps, however, other suitable clamping configurations may be utilized.

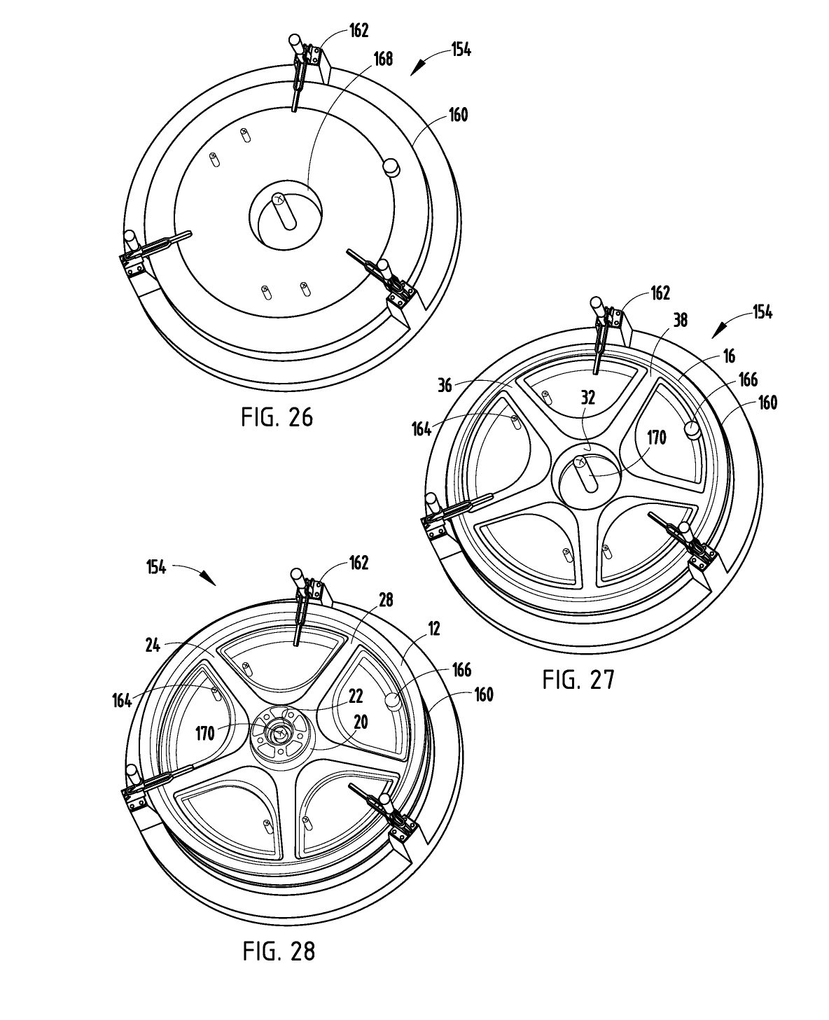

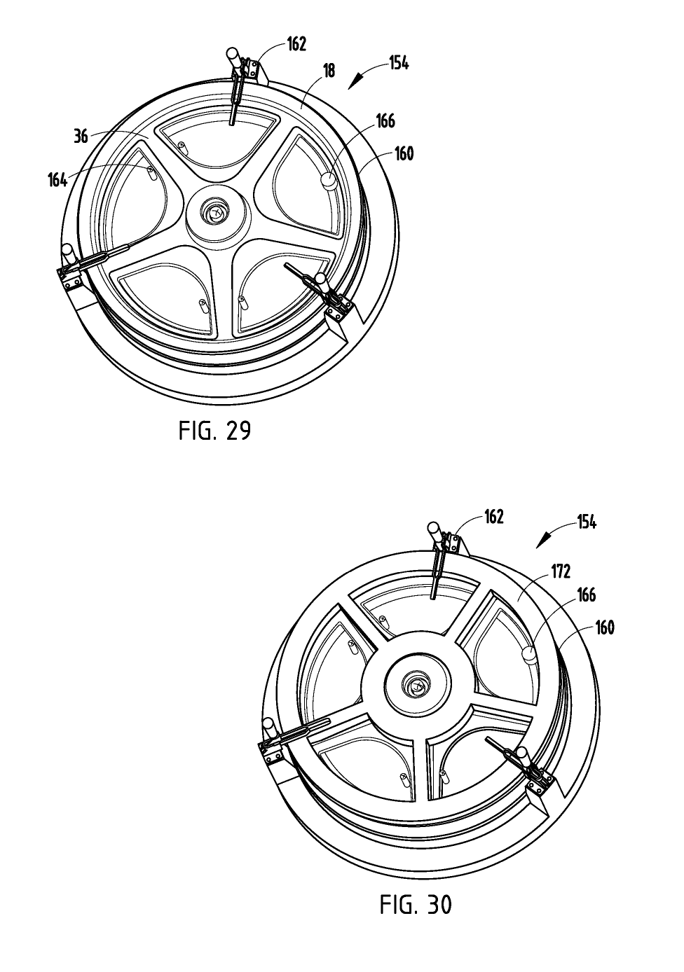

In assembly, the first cladding member 16 (FIG. 27) is placed within the fixture 160 and is radially aligned thereto by a plurality of spoke alignment pins 164 that abut an associated spoke 36, and a valve hole alignment pin 166, and axially aligned thereto by a hub alignment recess 168 that receive the central or hub portion 32 of the first cladding member 16 therein. An adhesive is then placed on the inner surface 38 of the first cladding member 16 before the wheel 12 (FIG. 28) is placed within the fixture 160 and upon the first cladding member 16. The wheel 12 is axially aligned with respect to the fixture 160 in a similar manner to that described above with respect to the first cladding member 16, and is axially aligned with the fixture 160 by a hub aperture alignment pin 170 that is received within the hub aperture 22 of the wheel 12, as well as by the central hub 20 that is received within the central or hub portion 32 of the first cladding member 16. Alternatively, a foam filling agent such as polyurethane foam, is then inserted into the gap formed between the first cladding member 16 and the wheel 12. The adhesive is again applied to the outer surface 28 of the wheel 12 after which the second clad member 18 (FIG. 29) is placed within the fixture 160 and upon the wheel 12. Radial alignment of the second clad member 18 with respect to the wheel 12, the first cladding member 16 and the fixture 160 is provided in a similar manner to that described above with respect to the first cladding member 16, while axial alignment thereof is provided by the engagement of the second cladding member 18 with the wheel 12. Alternatively, the foam filling agent is inserted into a gap formed between the second cladding member and the wheel. A clamping spacer 172 (FIG. 30) is then placed within the fixture 160 such that the clamping spacer 172 rests on the outer surface 40 of the second cladding member 18, subsequent to which the clamping members 162 are engaged so as to firmly hold the wheel assembly 10 upon the fixture 160 until such time as the adhesive cures allowing removal of the wheel assembly 10 from the fixture 160.

In the foregoing description, it will be readily appreciated by those skilled in the art that modifications may be made to the invention without departing from the concepts disclosed herein.

The invention claimed is:

1. A motorcycle wheel assembly, comprising:
a wheel having a first outer surface, a second outer surface opposite the first outer surface, a central hub region, an outer rim portion, and a centrally located hub aperture extending through the wheel;
a first wheel cladding having an outer surface and an inner surface facing the first outer surface of the wheel, and a first edge; and
a second wheel cladding having an outer surface and an inner surface facing the second surface of the wheel, and a second edge that engages the first edge of the first wheel, wherein at least a select one of the first edge and the second edge includes at least one first tab member, and wherein the remaining edge of the first wheel cladding and second wheel cladding includes a pair of second tab members that receive the at least one first tab member therebetween, thereby interconnecting the first and second wheel claddings together.

2. The motorcycle wheel assembly of claim 1, wherein the wheel includes at least one aperture extending therethough and located proximate the rim, and wherein the at least one first tab member and the second tab members are located within the at least one aperture and are located proximate the rim of the wheel.

3. The motorcycle wheel assembly of claim 1, wherein the wheel includes a plurality of spokes extending between the central hub region and outer rim portion, and wherein the at least one first tab member and the second tab members a located proximate at least one of the plurality of spokes.

4. The motorcycle wheel assembly of claim 1, wherein the at least one first tab member and the second tab members are interconnected to provide a seamless transition between the first wheel cladding and the second wheel cladding.

5. The motorcycle wheel assembly of claim 1, wherein the at least one first tab member includes a pair of first tab members that are interspaced with the second tab members.

6. The motorcycle wheel assembly of claim 1, wherein the at least one first tab member includes a single first tab member that is centrally located along the first edge of the first wheel cladding.

7. The motorcycle wheel assembly of claim 1, wherein the wheel comprises a metal.

8. The motorcycle wheel assembly of claim 1, wherein the first and second claddings comprise a plastic.

9. The motorcycle wheel assembly of claim 1, where at least a select one of the first and second wheel claddings include at least one axially extending alignment boss, and wherein the remaining of first and second wheel claddings includes at least one boss receiving aperture that receives the at least one axially extending alignment boss, thereby aligning the first and second wheel claddings with one another.

10. A motorcycle wheel assembly, comprising:
a wheel having a first outer surface, a second outer surface opposite the first outer surface, a central hub region, an outer rim portion, and a centrally located hub aperture extending through the wheel;
a first wheel cladding having an outer surface and an inner surface facing the first outer surface of the wheel, and a first edge;
a second wheel cladding having an outer surface and an inner surface facing the second surface of the wheel, and a second edge; and
a connector member extending radially along at least a select one of the central hub region and the outer rim portion, wherein the connector member is located between the first and second edges and provides a transition between the first and second wheel claddings.

11. The motorcycle wheel assembly of claim 10, wherein the connector member is separate from the wheel.

12. The motorcycle wheel assembly of claim 11, wherein the connected member is fixedly secured to the wheel.

13. The motorcycle wheel assembly of claim 10, wherein the connector is integral with the wheel.

14. The motorcycle wheel assembly of claim 10, wherein the connector member has an I-shaped cross-sectional configuration having a first flange, a second flange and a web portion extending between the first flange and the second flange, and where the first and second edges are located between the first and second flanges.

15. The motorcycle wheel assembly of claim 14, wherein the first and second edges abut the web portion of the connector member.

16. The motorcycle wheel assembly of claim 10, wherein the connector member has a T-shaped cross-sectional configuration having a flange and a web portion, and wherein first and second edges are a located between the wheel and web portion.

17. The motorcycle wheel assembly of claim 16, wherein the first and second edges abut the web portion of the connector member.

18. A motorcycle wheel assembly, comprising:
a wheel having a first outer surface, a second outer surface opposite the first outer surface, a central hub region, an outer rim portion, and a centrally located hub aperture extending through the wheel;
a first wheel cladding having an outer surface and an inner surface facing and at least partially abutting the first outer surface of the wheel;
a second wheel cladding having an outer surface and an inner surface facing and at least partially abutting the second outer surface of the wheel;
a third wheel cladding having an outer surface and an inner surface facing and at least partially abutting the outer surface of the first wheel cladding; and
a fourth wheel cladding having an outer surface and an inner surface facing and at least partially abutting the outer surface of the second wheel cladding.

19. The motorcycle wheel assembly of claim 18, wherein first and second wheel claddings extend radially between the central hub region and the outer rim portion, the first and second wheel claddings do not cover at least a portion of the central hub region, and wherein the third and fourth wheel cladding cover at least a portion of the central hub region not covered by the first and second wheel claddings.

20. The motorcycle wheel assembly of claim 19, wherein the third and fourth wheel claddings are completely underlayed by the first and second wheel claddings, respectively.

21. A motorcycle wheel assembly, comprising:
a wheel having a first outer surface, a second outer surface opposite the first outer surface, a central hub region, an outer rim portion, and a plurality of structural members extending radially between the central hub region and the outer rim portion defining a plurality of apertures therebetween;
a first wheel cladding having an outer surface and an inner surface facing the first outer surface of the wheel; and
a second wheel cladding having an outer surface and an inner surface facing the second surface of the wheel, wherein the first and second wheel claddings cooperate to completely cover each of the apertures, thereby providing the aesthetic appearance of a solid wheel.

22. A motorcycle wheel assembly, comprising:
a wheel having a first outer surface, a second outer surface opposite the first outer surface, a central hub region, an outer rim portion, a rim flange circumscribing the rim portion, and a centrally located hub aperture extending through the wheel; and
at least one wheel cladding having an outer surface and an inner surface facing at least one of the outer surfaces of the wheel, an outer radial edge and an inner radial edge, wherein the outer radial edge of the wheel cladding extends up to but does not cover the rim flange.

23. The motorcycle wheel assembly of claim 22, wherein the at least one wheel cladding includes a first wheel cladding and a second wheel cladding, and wherein the inner surface of the first wheel cladding faces the first outer surface of wheel and the inner surface of the second wheel cladding faces the second outer surface of the wheel.

24. The motorcycle wheel assembly of claim 22, wherein the outer surface of the at least one wheel cladding proximate the inner radial edge is substantially flush with the corresponding outer surface of the wheel.

25. The motorcycle wheel assembly of claim 22, wherein the inner radial edge of the at least one wheel cladding is located between the central hub region and the outer rim portion, and wherein the at least one wheel cladding does not cover any portion of the central hub region.

26. A method for manufacturing a motorcycle wheel assembly, comprising:
placing a first wheel cladding on a fixture such that an outer surface of the first wheel cladding faces the fixture;
applying an adhesive to a select one of an inner surface of the first wheel cladding and a first outer surface of a wheel;
placing the wheel on the first wheel cladding such that the first outer surface of the wheel faces the inner surface of the first wheel cladding;
applying an adhesive to a select one of a second outer surface of the wheel and an inner surface of a second wheel cladding;
placing the second wheel cladding on the wheel such that the inner surface of the second wheel cladding faces the second outer surface of the wheel;
placing a spacer on an outer surface of the second wheel cladding; and
applying a clamping pressure to the spacer, thereby clamping the first wheel cladding, the wheel and the second wheel cladding together.

27. The method of claim 26, wherein the clamping pressure is applied by a plurality of manual clamps.

28. The method of claim 26, wherein the adhesive applied between the first wheel cladding and the wheel, and between the second wheel cladding and the wheel comprises an RTV-type adhesive.

29. The method of claim 29, wherein the step of placing the wheel on the first wheel cladding creates a first gap between the first wheel cladding and the wheel; and further including:
filling the first gap with a filler material.

30. The method of claim 29, wherein the step of filling the first gap includes providing the filler material as comprising polyurethane.

31. The method of claim 31, wherein the step of filling the first gap in completed prior to the step of placing the second wheel cladding on the wheel.

32. The method of claim 29, wherein the step of placing the second cladding on the wheel creates a second gap between the second wheel cladding and the wheel; and further including:
filling the second gap with the filler material.

33. The method of claim 32, wherein the steps of filling the first and second gaps include providing the filler material as comprising polyurethane.

34. The method of claim 32, wherein the step of filling the second gap in completed prior to the step of placing the spacer on the second wheel cladding.
